(19) United States
(12) Patent Application Publication
(10) Pub. No.: US 2011/0103348 A1
(43) Pub. Date: May 5, 2011

(54) HANDOVER PROCESSING METHOD, AND MOBILE TERMINAL AND COMMUNICATION MANAGEMENT DEVICE USED IN SAID METHOD

(75) Inventors: Takako Hori, Kanagawa (JP); Shinkichi Ikeda, Kanagawa (JP); Jun Hirano, Kanagawa (JP); Takashi Aramaki, Osaka (JP)

(73) Assignee: Panasonic Corporation, Osaka (JP)

(21) Appl. No.: 13/001,542

(22) PCT Filed: Jul. 3, 2009
(86) PCT No.: PCT/JP2009/003101

§ 371 Date: Dec. 27, 2010

(30) Foreign Application Priority Data
Jul. 7, 2008 (JP) 2008-176406

(51) Int. Cl. H04W 4/00

(52) U.S. Cl. 370/331

(57) ABSTRACT

Provided is a technique to provide a handover processing method that allows a mobile terminal to be handed over seamlessly while preventing occurrence of double reservation. The method includes a step where a mobile terminal (100) decides to connect to a desired access network (113) and detects the possibility of occurrence of a network-initiated handover processing performed by a predetermined device of the communication network as one of the controlling entities, and a step where the mobile terminal transmits a connection request message requesting a connection to the desired access network, the connection request message including information to maintain the connection with the access network with which the mobile terminal is currently connecting, to a base station disposed in the desired access network based on a detection result of the detection step.

### TECHNICAL FIELD

The present invention relates to a handover processing method of a mobile terminal in the case where a plurality of entities exists to control a mobile terminal handover and mobile terminal handovers by the respective control entities occur, and relates to a mobile terminal and a communication management device used in the method.

### BACKGROUND ART

In a large-scale network with mobility support for next-generation terminal, Proxy Mobile IP (PMIP) is available that is described in Non-Patent Document 1. According to PMIP, mobility (handover) of a mobile terminal (MN: Mobile Node) at an Internet Protocol (IP) layer is managed by a network side. Meanwhile, System Architecture Evolution (SAE) of 3rd Generation Partnership Project (3GPP) specifies a next-generation Packet Switched (PS) network (see Non-Patent Document 2, Non-Patent Document 3). FIG. 14 (described in Non-Patent Document 3) illustrates a partial network diagram.

In a 3GPP access, an eNodeB (not illustrated) as a radio access point for a User Equipment (UE) and a Mobility Management Entity (MME) (not illustrated) managing a handover at a link layer exist. As shown in FIG. 14, both of a handover of a UE as a 3GPP mobile terminal between 3GPP accesses and a handover thereof between a 3GPP access and a non-3GPP network are supported in Non-Patent Document 2. In order to manage this handover of a UE at an IP layer, PMIP is mainly used.

FIG. 15 illustrates an exemplary mobility signaling flow for a UE between 3GPP accesses described in Non-Patent Document 2. As shown in FIG. 15, preparation for a handover is performed by a network side (Step S1501), a handover starts (Step S1502), and the handover is completed (Step S1503). The mobility herein is decided by a network side, and the handover is initiated by a network side (a network initiated handover). In this case, the UE cannot notice the handover being implemented.

FIG. 16 illustrates an exemplary mobility signaling flow for a UE from a 3GPP access to a Trusted non-3GPP IP access (simply called a non-3GPP access as well) described in Non-Patent Document 3. As shown in FIG. 16, the handover herein is initiated by a UE side (a UE initiated handover). Assume herein that the UE has already established a communication bearer with the 3GPP access (Step S1601). As a result of checking a measurement result of radio waves receivable from the non-3GPP access network with respect to a handover policy, the UE decides to start a handover to the non-3GPP access (Step S1602), and starts an access authentication processing to connect with the non-3GPP access (Step S1603). When the access authentication is completed so that a connection is authorized (authentication, authorization), a connection processing at a layer 3 (IP layer) starts (L3 (Layer 3) attach trigger: Step S1604).

As a result, a node (e.g., a not-illustrated Mobile Access Gateway (MAG) in the non-3GPP access network acquires and sets QoS policy and accounting setting information to be set with a core network from a PCRF (gateway control session configuration request (Gateway Control and QoS Policy Rules Request): Step S1605, gateway control session configuration response (Ack Gateway Control and QoS Policy Rules Request): Step S1606). Subsequently, the MAG transmits a proxy binding update (proxy BU) to a PDN gateway (PDN-GW) (Step S1607), and the PDN-GW acquires and sets a QoS policy and accounting setting information from the PCRF (policy and accounting information request (Modification of IP-CAN Session): Step S1608, policy and accounting information provisioning (Ack IP-CAN Session Modification): Step S1609).

The PDN-GW further performs AAA authentication (Step S1610). When these processes succeed, the PDN-GW returns a proxy BA (Binding Ack) to the MAG (Step S1611), so that a PMIPv6 tunnel is configured between the MAG and the PDN-GW (Step S1613). Receiving the proxy BA, the MAG transfers an IP address/prefix distributed from the PDN-GW to the UE so as to complete the connection processing at a L3 level (Step S1612). Then, finally, a 3GPP bearer of a handover source access is released to complete the UE initiated handover processing (3GPP EPS bearer resource release: Step S1614). Herein, the 3GPP EPS bearer may be released by the UE or by the PDN-GW.

FIG. 17 illustrates an exemplary Bearer (link level connection between a UE and a PDN-GW in 3GPP) Release (bearer release) signaling flow described in Non-Patent Document 2. As shown in FIG. 17, receiving a radio bearer release request (Step S1701), a UE transmits a radio bearer release response (Step S1702) to implement bearer release.

### PRIOR ART DOCUMENT

### Non-Patent Document

[Non-Patent Document 1] S. Gundavelli et al, “Proxy Mobile IPv6”, draft-ietf-netlmm-proxymip6-11.txt, Feb. 25, 2008.

[Non-Patent Document 2] “General Packet Radio Service (GPRS) enhancements for Evolved Universal Terrestrial Radio Access Network (E-UTRAN) access (Release 8)”, 3GPP TS 23.401 V8.1.0 March 2008.

[Non-Patent Document 3] “Architecture enhancements for non-3GPP accesses (Release 8)”, 3GPP TS 23.402 V8.1.1 March 2008.

Assume herein that a UE currently is connecting with a 3GPP access for communication. Herein, while the UE finds a non-3GPP access and tries to switch a connection therewith, the 3GPP access side starts a network initiated handover. Then, handovers on both sides will fail (interrupted), and further wasted signaling will occur for the bearer release. FIG. 18 illustrates one example thereof.

In FIG. 18, after signaling relating to a handover from a 3GPP access to a non-3GPP access is completed, a bearer release processing transmitted from a network side (Step S1806: Delete Bearer Request) causes a failure in a handover from a 3GPP access to a 3GPP access (interruption occurs in data transmission/reception) and further a handover signal (Step S1807: Update Bearer Request) from a 3GPP access to a 3GPP access updates handover information (position registration information of a UE), thus leading to a failure in a handover from a 3GPP access to a non-3GPP access as well.

Thus, when 3GPP is disconnected and then a connection is carried out with a non-3GPP, a problem (a break before make problem) occurs that a handover is not carried out seamlessly. When 3GPP is not disconnected, a problem of double reservation will occur.

### SUMMARY OF THE INVENTION

In view of the above-stated problems, it is an object of the present invention to provide a handover processing method enabling a seamless handover of a mobile terminal and capable of avoiding double reservation, and to provide a mobile terminal and a communication management device used in the method.

In order to fulfill the above-stated object, the present invention provides a handover processing method for a mobile terminal, the mobile terminal performing communication with a correspondent node via a communication network including a plurality of access networks in a communication system, a plurality of control entities that control a handover of the mobile terminal existing in the communication system. The handover processing method includes the steps of: a step where the mobile terminal decides to connect with a desired access network among the plurality of access networks; a step where the mobile terminal detects a possibility of occurrence of a network initiated handover processing a predetermined device of the communication network performs as one of the control entities; and a step where the mobile terminal transmits, based on the detection, a connection request message to a base station disposed in the desired access network, the connection request message requesting a connection with the desired access network and including predetermined information to maintain a connection with an access network with which the mobile terminal is currently connecting. This configuration allows a mobile terminal to be handed over seamlessly while preventing occurrence of double reservation. The present invention assumes the case where at least one base station exists in an access network.

In the handover processing method of the present invention, the possibility of occurrence of a network initiated handover processing preferably is detected based on whether or not radio wave intensity the mobile terminal receives being predetermined radio wave intensity or lower, or whether or not the mobile terminal transmitting a report indicating a result of examination on an access network environment surrounding the mobile terminal. This configuration enables appropriate detection of the possibility of occurrence of a network initiated handover processing.

In the handover processing method of the present invention, the predetermined information preferably includes information indicating a policy of a handover processing when a handover of the mobile terminal is occurred. This configuration allows a release processing of the current connection to be temporarily put on hold.

In the handover processing method of the present invention, when the mobile terminal detects the network initiated handover processing after the connection request message is transmitted, the mobile terminal preferably transmits, to the base station disposed in the desired access network, a release message to disconnect the connection with the desired access network. This configuration can avoid double reservation.

In the handover processing method of the present invention, the predetermined information preferably includes information to make a predetermined device of the communication network managing communication with the correspondent node conduct a processing in accordance with information indicating a policy of a handover processing of the mobile terminal, the information being kept by the predetermined device. This configuration allows a release processing of the current connection to be temporarily put on hold.

The present invention provides a handover processing method for a mobile terminal, the mobile terminal performing communication with a correspondent node via a communication network including a plurality of access networks in a communication system, a plurality of control entities that control a handover of the mobile terminal existing in the communication system. The handover processing method includes the steps of: when a predetermined device of the communication network managing communication of the mobile terminal with the correspondent node receives a first message and a second message, the first message from the mobile terminal requesting connection switching to a base station in a desired access network among the plurality of access networks, and the second message requesting connection switching to a base station of a connection target of the mobile terminal that the communication network decides as an entity, a step where a predetermined device of the communication network determines whether or not a message to release a connection of the mobile terminal with a base station with which the mobile terminal is currently connecting is transmitted to the base station with which the mobile terminal is currently connecting after reception of the first message and before reception of the second message; a step of, when it is determined that the message is transmitted, deciding not to accept a processing of the second message; and a step of, when it is determined that the message is not transmitted, determining that the second message is valid and performing a processing in accordance with the second message. This configuration allows a mobile terminal to be handed over seamlessly while preventing occurrence of double reservation. Herein, the first and the second messages correspond to position registration messages described later.

In the handover processing method of the present invention, when it is decided not to accept a processing of the second message, a predetermined device of the communication network preferably transmits an error message indicating not acceptance to a base station that transmits the second message. With this configuration, the mobile terminal can notice that a network initiated handover will not be implemented.

In the handover processing method of the present invention, when a processing is performed in accordance with the second message, a predetermined device of the communication network preferably transmits an error message indicating that the mobile terminal cannot perform a desired connection to the mobile terminal via a base station that transmits the first message. With this configuration, the mobile terminal can tell that a UE initiated handover will not be implemented.

The present invention provides a mobile terminal used in a handover processing method for the mobile terminal, the mobile terminal performing communication with a correspondent node via a communication network including a plurality of access networks in a communication system, a plurality of control entities that control a handover of the mobile terminal existing in the communication system, there being a possibility of each of the plurality of control entities generating a handover processing of the mobile terminal. The mobile terminal includes: decision unit that decides a connection with a desired access network among the plurality of access networks; detection unit that detects a possibility of occurrence of a network initiated handover processing a predetermined device of the communication network performs as one of the control entities; message generation unit that generates a connection request message based on the detection by the detection unit, the connection request message requesting a connection with the desired access network and including predetermined information to maintain a connection with an access network with which the mobile terminal is currently connecting; and transmission unit that transmits the generated connection request message to a base station disposed in the desired access network. This configuration allows a mobile terminal to be handed over seamlessly while preventing occurrence of double reservation.

In the mobile terminal of the present invention, the possibility of occurrence of a network initiated handover processing is preferably detected by the detection unit based on whether or not radio wave intensity the mobile terminal receives being predetermined radio wave intensity or lower, or whether or not the mobile terminal transmitting a report indicating a result of examination on an access network environment surrounding the mobile terminal. This configuration enables appropriate detection of the possibility of occurrence of a network initiated handover processing.

In the mobile terminal of the present invention, the predetermined information preferably includes information indicating a policy of a handover processing when a handover of the mobile terminal is occurred. This configuration allows a release processing of the current connection to be temporarily put on hold.

In the mobile terminal of the present invention, when detecting the network initiated handover processing after the connection request message is transmitted, preferably the message generation unit generates a release message to disconnect the connection with the desired access network, and the transmission unit transmits the generated release message to the base station disposed in the desired access network. This configuration can avoid double reservation.

In the mobile terminal of the present invention, the predetermined information preferably includes information to make a predetermined device of the communication network managing communication with the correspondent node conduct a processing in accordance with information indicating a policy of a handover processing of the mobile terminal, the information being kept by the predetermined device. This configuration allows a release processing of the current connection to be temporarily put on hold.

The present invention provides a communication management device used in a handover processing method for a mobile terminal, the mobile terminal performing communication with a correspondent node via a communication network including a plurality of access networks in a communication system, a plurality of control entities that control a handover of the mobile terminal existing in the communication system. The communication management device managing the communication includes: reception unit that receives a first message and a second message, the first message from the mobile terminal requesting connection switching to a base station in a desired access network among the plurality of access networks, and the second message requesting connection switching to a base station of a connection target of the mobile terminal that the communication network decides as an entity; transmission unit that transmits a release message to release a connection of the mobile terminal with a base station with which the mobile terminal is currently connecting to the base station with which the mobile terminal is currently connecting; determination unit that, after reception of the first message and before reception of the second message, determines whether or not the transmission unit transmits the release message to the base station with which the mobile terminal is currently connecting; and processing unit that, when it is determined that the message is transmitted, decides not to accept a processing of the second message; and when it is determined that the message is not transmitted, determines that the second message is valid and performs a processing in accordance with the second message. This configuration allows a mobile terminal to be handed over seamlessly while preventing occurrence of double reservation. The communication management device herein corresponds to a SG described later.

The communication management device of the present invention preferably further includes message generation unit that, when the processing unit decides not to accept a processing of the second message, generates an error message indicating not acceptance. The transmission unit preferably transmits the generated error message to a base station that transmits the second message. With this configuration, the mobile terminal can tell that a network initiated handover will not be implemented.

The communication management device of the present invention preferably further includes message generation unit that, when the processing unit performs a processing in accordance with the second message, generates an error message indicating that the mobile terminal cannot perform a desired connection. The transmission unit preferably transmits the generated error message to the mobile terminal via a base station that transmits the first message. With this configuration, the mobile terminal can notice that a UE initiated handover will not be implemented.

A handover processing method, and a mobile terminal and a communication management device used in the method of the present invention allow a mobile terminal to be handed over seamlessly while preventing occurrence of double reservation.

### BRIEF DESCRIPTION OF THE DRAWINGS

FIG. 1 is a configuration diagram illustrating an exemplary configuration of a mobile communication system in Embodiments 1 and 2 of the present invention.

FIG. 2 is a configuration diagram illustrating an exemplary configuration of a UE according to Embodiment 1 of the present invention.

FIG. 3 is a flowchart illustrating an exemplary method to detect a possibility of occurrence of a network initiated handover in Embodiment 1 of the present invention.

FIG. 4 is a flowchart illustrating another exemplary method to detect a possibility of occurrence of a network initiated handover in Embodiment 1 of the present invention.

FIG. 5 is an exemplary message format in Embodiments 1 and 2 of the present invention.

FIG. 6 is a sequence chart illustrating an exemplary message sequence in the processing in Embodiment 1 of the present invention.

FIG. 7 is a sequence chart illustrating another exemplary message sequence in the processing in Embodiment 1 of the present invention.

FIG. 8 is a sequence chart illustrating still another exemplary message sequence in the processing in Embodiment 1 of the present invention.

FIG. 9 is a configuration diagram illustrating an exemplary configuration of a SG according to Embodiments 1 and 2 of the present invention.

FIG. 10 is a flowchart illustrating an exemplary analysis flow to analyze the content of a message by the SG according to Embodiment 1 of the present invention.

FIG. 11 is a sequence chart illustrating an exemplary message sequence in the processing in Embodiment 2 of the present invention.

FIG. 12 is a sequence chart illustrating another exemplary message sequence in the processing in Embodiment 2 of the present invention.

FIG. 13 is a flowchart illustrating an exemplary processing by policy enforcement unit of the SG according to Embodiment 2 of the present invention.

FIG. 14 illustrates an exemplary conventional network.

FIG. 15 is a sequence chart illustrating one example of a conventional mobility signaling sequence for a UR between 3GPP accesses.

FIG. 16 is a sequence chart illustrating one example of a conventional mobility signaling sequence for a UE from a 3GPP access to a Trusted non-3GPP access IP access.

FIG. 17 is a sequence chart illustrating one example of a conventional signaling sequence for bearer release.

FIG. 18 is a sequence chart to describe a problem in the conventional UE handover.

FIG. 19 is a sequence chart illustrating exemplary UE initiated release message transmission.

### DESCRIPTION OF EMBODIMENTS

### Embodiment 1

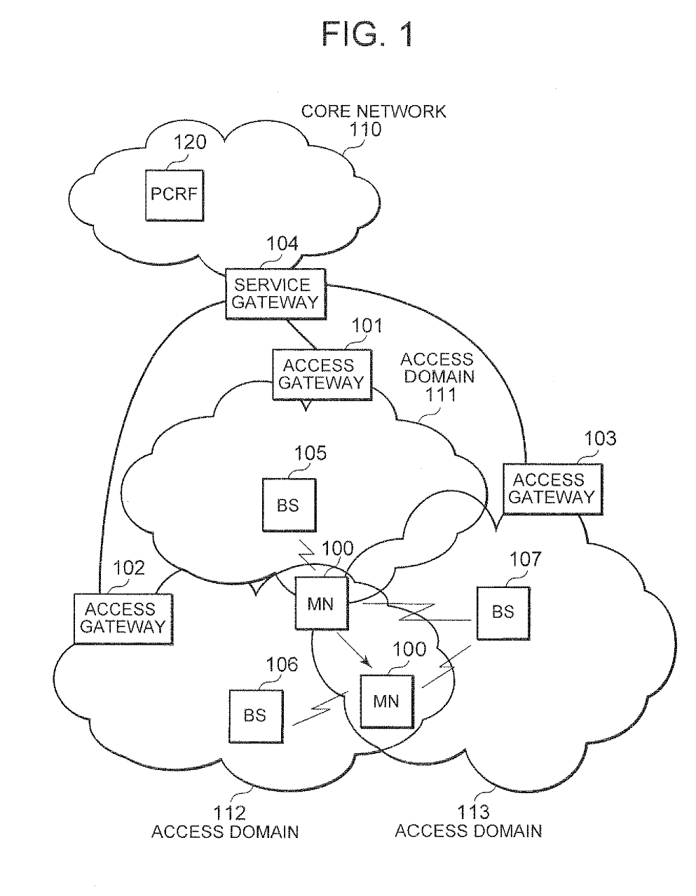

Referring to FIG. 1, Embodiment 1 of the present invention is described below. An access domain (AD) 111 and an AD 112 are access networks of a same type, and an AD 113 is an access network of a different type from the AD 111 and the AD 112. In the AD 111, the AD 112 and the AD 113, a Base Station (BS) 105, a BS 106 and a BS 107 as radio access points for a mobile terminal MN 100 (hereinafter the MN 100 may be described as a UE 100) exist respectively, and the BS 105, the BS 106 and the BS 107 connect to an access gateway (AG) 101, an AG 102 and an AG 103, respectively.

The AG manages the mobility in the AD of the MN 100 connected with the AD. The AG 101, the AG 102 and the AG 103 each connect with a Service Gateway (SG) 104. The SG 104 manages mobility of the MN 100 between ADs and mobility when an address of the MN 100 is changed in an AD. The ADs may be 3GPP access networks such as UMTS Terrestrial Radio Access Network (UTRAN), GSM EDGE Radio Access Network (GERAN) and Evolved UTRAN (EUTRAN); non-3GPP access networks such as Wireless LAN (WLAN), Worldwide Interoperability for Microwave Access (WiMAX), High Rate Packet Data (HRPD; standardized at 3GPP2) and Next Generation Network (NGN); or Interworking Wireless LAN (I-WLAN).

The BSs may be 3GPP base stations (e.g., eNodeB) or access points such as WLAN, WiMAX and I-WLANs, for example. The AGs may be a Serving Gateway described in Non-Patent Document 2, or an ePDG or an Access Gateway (AGW) described in Non-Patent Document 3. The AGs may be a MAG described in Non-Patent Document 1. The Service Gateway may be a PDN GW described in Non-Patent Document 2 or a home agent or a local mobility anchor (LMA) described in Non-Patent Document 1, for example. The MN 100 connects with an Application Service Domain not illustrated via these nodes, and receives an application service. The Application Service Domain may be the Internet, an IP packet network such as an IMS (IP Multimedia Subsystem) network each operator company provides or other Packet Data Networks (PDNs), for example. Hereinafter, the AG 101, the AG 102 and the AG 103 may be described as the AD 111, the AD 112 and the AD 113, respectively. Among them, the MN and the BSs are examples of control entities relating to a decision of a MN handover.

Now the MN 100 tries a handover from the AD 111 to the AD 113. At this time, when the MN 100 finds a possible network initiated handover being initiated from the AD 111 to the AD 112, the MN 100 sends, to the SG 104, a policy as a handover processing policy so that a handover procedure from the AD 111 to the AD 113 does not interfere with the network initiated handover from the AD 111 to the AD 112.

The possibility of occurrence of a network initiated handover is detected (recognized) by the following means, for example. As first means, the weakness of radio waves received from a network (access network) currently connecting is detected, whereby the possibility of handover occurrence can be detected. As second means, transmission of a measurement report determined as inducing a network initiated handover in a network currently connecting is detected, whereby the possibility of handover occurrence can be detected. For instance, the possibility of handover occurrence can be detected by detecting transmission of a report indicating that a wireless environment in the AD 112 is overwhelmingly more preferable than in the AD 111.

Further, a history indicating whether a network initiated handover being implemented or not may be checked with respect to the contents of the measurement reports transmitted so far, whereby a condition to initiate a network initiated handover is estimated, or a condition to initiate a network initiated handover may be downloaded and used for the estimation.

The above-stated policy is included in a connection request message to the AD 113 and is transmitted to the SG 104 (a node through which signaling relating to both of the handover from the AD 111 to the AD 112 and the handover from the AD 111 to the AD 113 transit). Alternatively, the policy may be transmitted beforehand to the SG 104, and a trigger to make this policy valid may be included in a connection request message to the AD 113 and be transmitted to the SG 104.

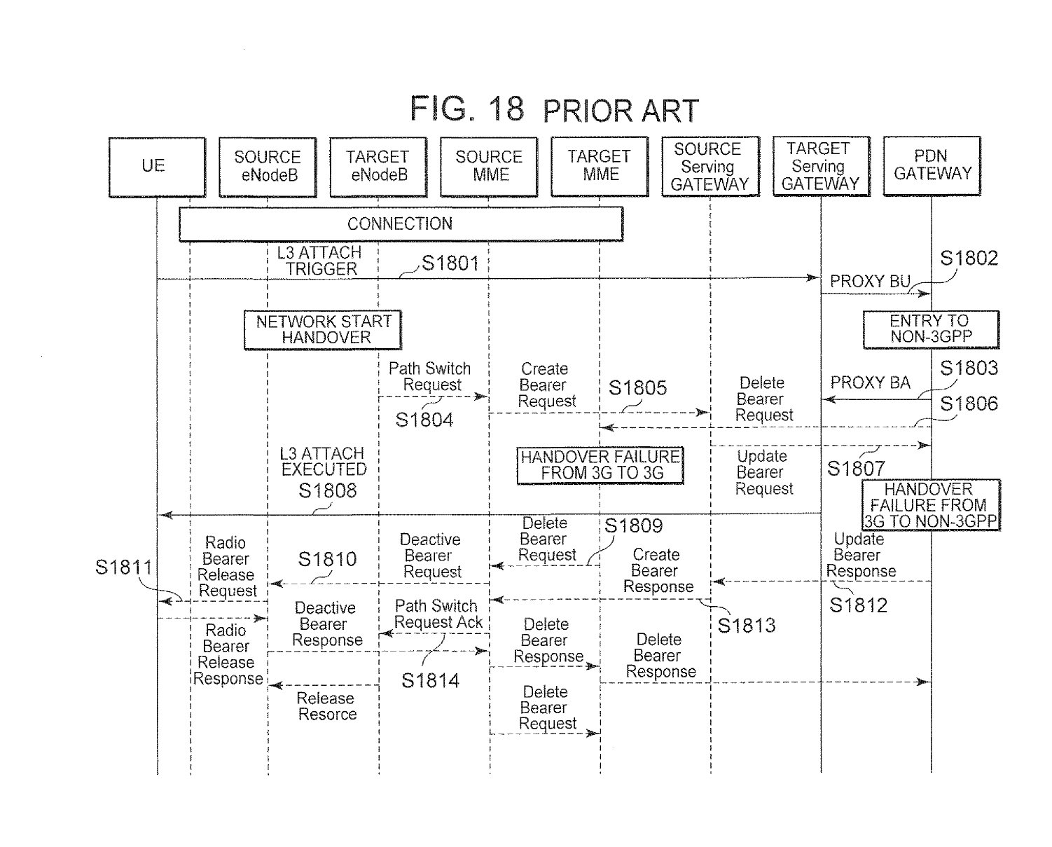

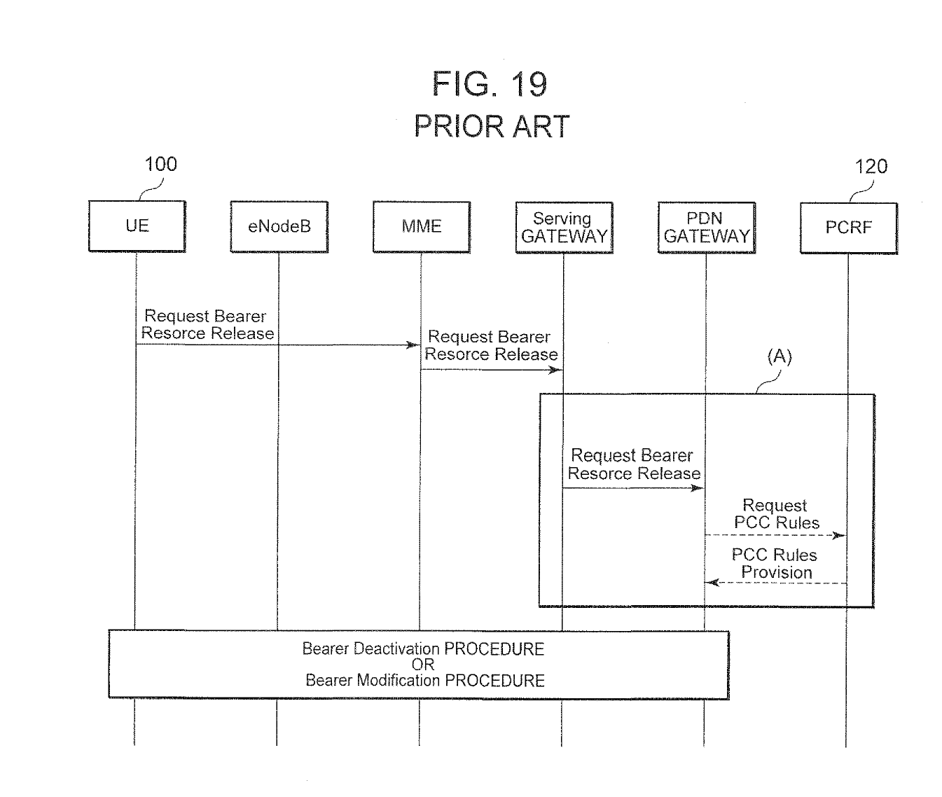

This policy implements the followings, for example: 1. To put on hold in the SG 104 a release processing (e.g., Delete Bearer Request at Step S1806 of FIG. 18) to the AD 111 path following the handover from the AD 111 to the AD 113; 2. In a state where the UE 100 completes the handover to the AD 113 and is ready to exchange of data with a correspondent node and when it is determined that the connection status maintained in the AD 111 becomes stable again (radio waves status becomes stable, for example), to transmit a release message initiated by the UE (to authorize transmission by the UE 100) (e.g., Request Bearer Resource Release of Non-Patent Document 2, see FIG. 19); and 3. When the UE 100 detects that a network initiated handover from the AD 111 to the AD 112 occurs during a handover processing from the AD 111 to the AD 113 or immediately after the handover to the AD 113 is completely performed, the UE 100 makes a path through the AD 113 released. Thereby, a handover of the UE 100 becomes seamless and double reservation of the handover can be avoided.

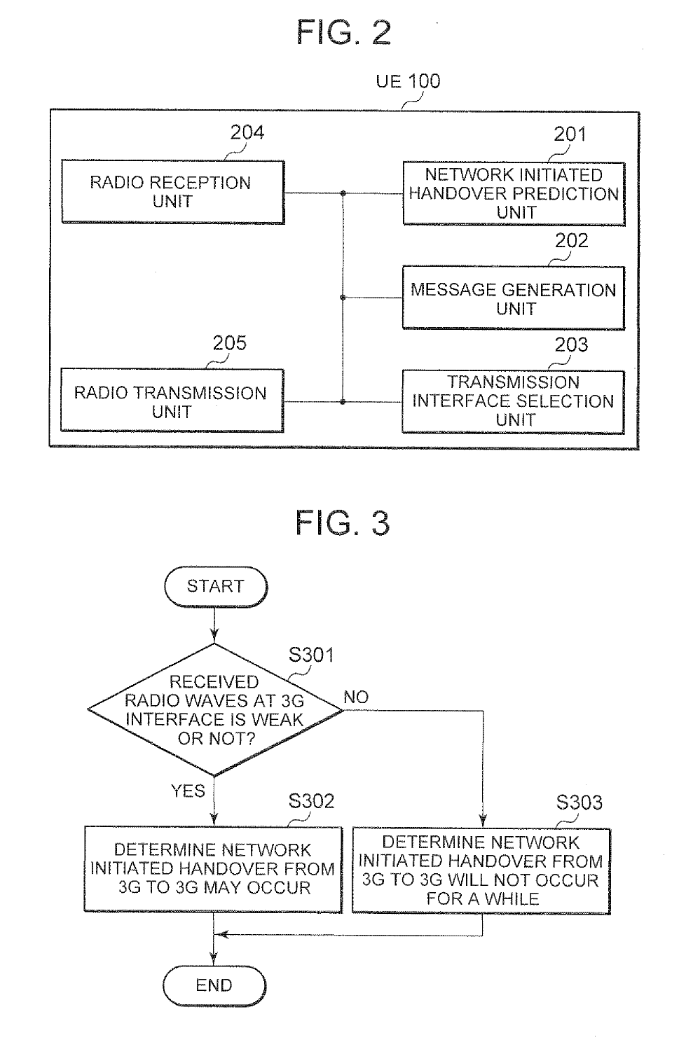

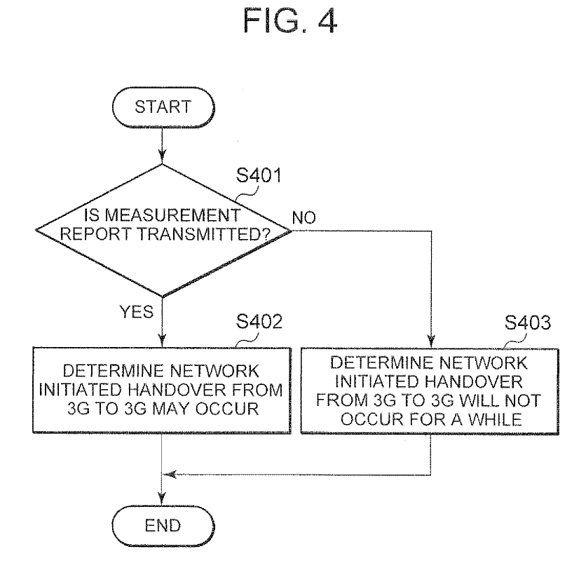

FIG. 2 illustrates an exemplary configuration of a UE according to Embodiment 1. Network initiated handover prediction unit 201 is means to detect (understand) a possibility of occurrence of the above-stated network initiated handover. FIG. 3 and FIG. 4 illustrate an exemplary detection method. FIG. 3 is a flowchart illustrating the case where a handover possibility is recognized by detecting weakness of radio waves received from a network (access network) currently connecting. The network initiated handover prediction unit 201 determines whether received radio waves at a 3G interface is weak or not (for example, lower than predetermined radio wave intensity) (Step S301), and if it is determined as weak, determines that a network initiated handover from a 3G to a 3G may occur (Step S302). On the other hand, if it is not determined as weak, the network initiated handover prediction unit 201 determines that a network initiated handover from a 3G to a 3G will not occur for a while (Step S303).

FIG. 4 is a flowchart illustrating the case where a handover possibility is recognized by detecting transmission of a measurement report determined as inducing a network initiated handover. The network initiated handover prediction unit 201 determines whether a measurement report determined as inducing a network initiated handover is transmitted or not (Step S401). If it is determined that the measurement report is transmitted, the network initiated handover prediction unit 201 determines that a network initiated handover from a 3G to a 3G may occur (Step S402). On the other hand, if it is not determined that the measurement report is transmitted, the network initiated handover prediction unit 201 determines that a network initiated handover from a 3G to a 3G will not occur for a while (Step S403).

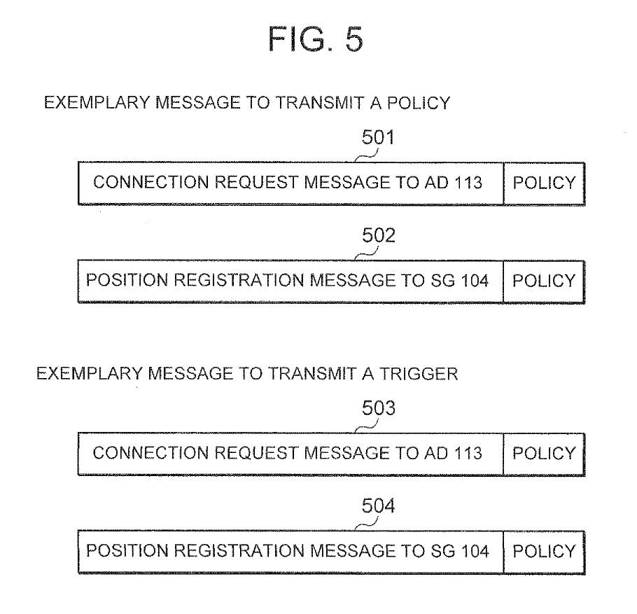

Message generation unit 202 is means to generate a message to transmit the above-stated policy and a trigger to make the policy valid. FIG. 5 is an exemplary message format that the message generation unit 202 generates. Herein, connection request messages 501, 503 to the AD 113 shown in FIG. 5 may be expansion of a Router Solicitation message described in Non-Patent Document 1 or a totally new message, for example, and position registration messages 502, 504 to the SG 104 may be a Proxy Binding Update message described in Non-Patent Document 1 or a message having a function similar thereto, for example.

Transmission interface selection unit 203 is means to select an interface from which a message is transmitted, i.e., whether a message is to be transmitted from an interface on the AD 111 (and the AD 112) side or from an interface from the AD 113 side. Radio reception unit 204 is means to receive a message or the like from the outside, and radio transmission unit 205 is means to transmit a message or the like to the outside.

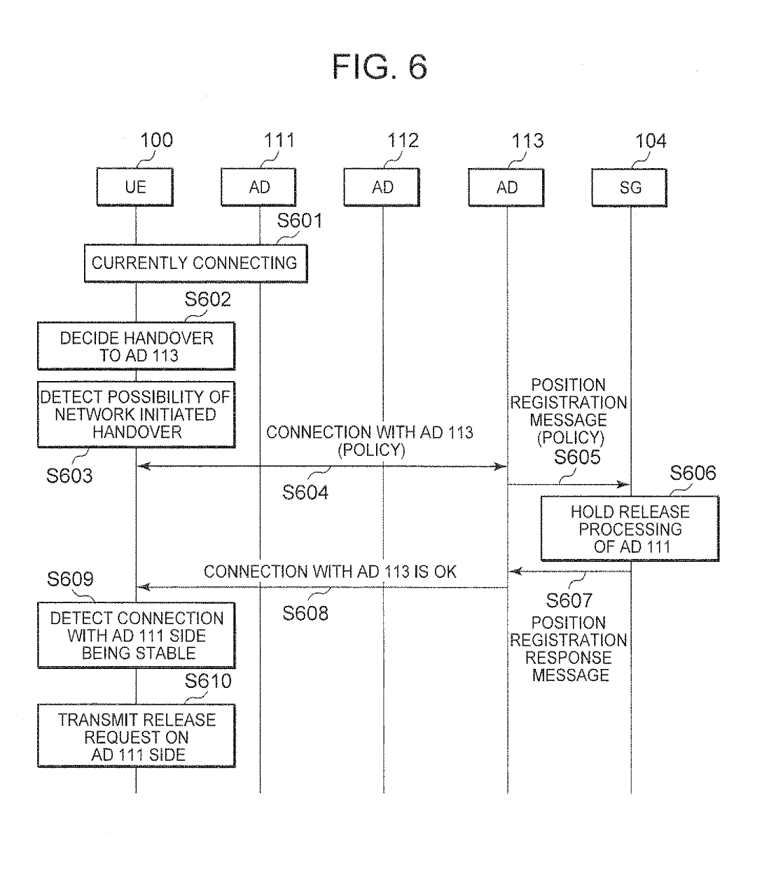

FIG. 6 through FIG. 8 illustrate a message flow in Embodiment 1. FIG. 6 is a flow where the policy is included in the connection request message to the AD 113 and is transmitted to the SG 104, and after the UE 100 detects that the connection on the AD 111 side becomes stable, the UE 100 transmits a release request on the AD 111 side. As shown in FIG. 6, the UE 100 connects with the AD 111 (Step S601), and the UE 100 decides a handover to the AD 113 (Step S602).

Thereafter or at the same time, the UE 100 detects (understands) a possibility of a network initiated handover occurring (Step S603). The UE 100 transmits a connection request message including a policy to the AD 113 (Step S604), and the AD 113 transmits a position registration message including the policy to the SG 104 (Step S605). Based on the policy, the SG 104 puts on hold a release processing to the AD 111 (Step S606), and transmits a position registration response message to the AD 113 (Step S607). Based on the position registration response message, the AD 113 transmits a message indicating that a connection with the AD 113 is OK (Step S608). The UE 100 detects that the connection on the AD 111 side becomes stable (Step S609) and determines that a network initiated handover will not occur, and thereafter the UE 100 transmits a release request to the bearer on the AD 111 side (Step S610).

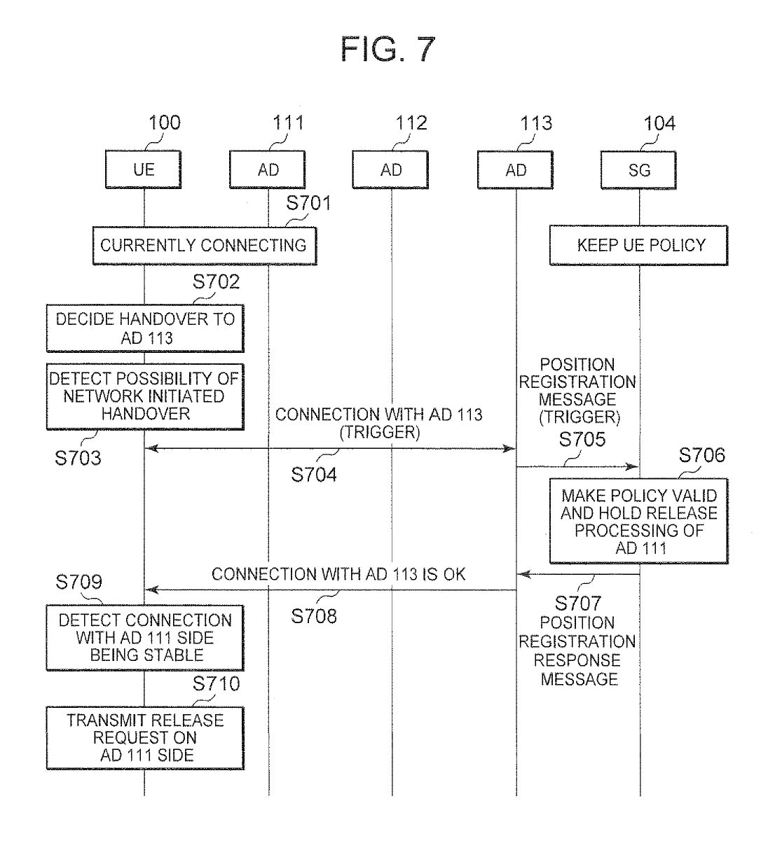

FIG. 7 illustrates a flow, in the case where the SG 104 keeps a policy of the UE 100 beforehand, to make this policy valid by a trigger. As shown in FIG. 7, the UE 100 connects with the AD 111 (Step S701), and the UE 100 decides a handover to the AD 113 (Step S702). At this time, the SG 104 keeps a policy of the UE 100 beforehand. Thereafter, the UE 100 detects (understands) a possibility of a network initiated handover occurring (Step S703).

The UE 100 transmits, to the AD 113, a connection request message including a trigger to make the policy valid (Step S704), and the AD 113 transmits a position registration message including the trigger to the SG 104 (Step S705). Based on the trigger, the SG 104 makes the policy valid, puts on hold a release processing to the AD 111 (Step S706), and transmits a position registration response message to the AD 113 (Step S707). Based on the position registration response message, the AD 113 transmits a message indicating that a connection with the AD 113 is OK (Step S708). The UE 100 detects that the connection on the AD 111 side becomes stable (Step S709), and determines that a network initiated handover will not occur, and thereafter the UE 100 transmits a release request on the AD 111 side (Step S710).

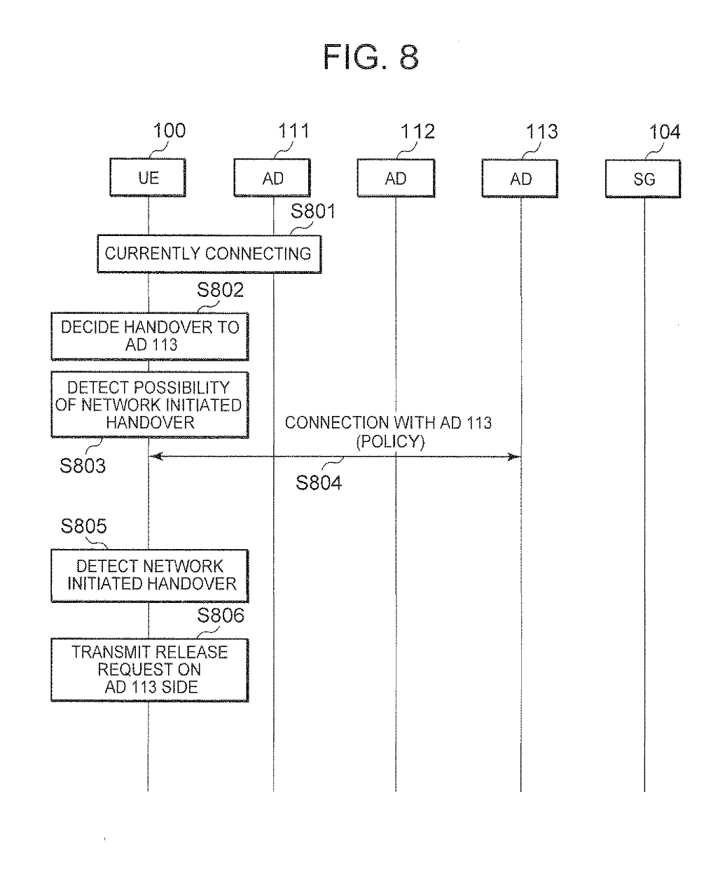

FIG. 8 illustrates a flow in the case where a network initiated handover occurs during a handover processing from the AD 111 to the AD 113. As shown in FIG. 8, the UE 100 connects with the AD 111 (Step S801), and the UE 100 decides a handover to the AD 113 (Step S802). Thereafter, the UE 100 detects (understands) a possibility of a network initiated handover occurring (Step S803). The UE 100 transmits a connection request message including the policy to the AD 113 (Step S804). Thereafter, when detecting a network initiated handover during the handover processing (Step S805), the UE 100 transmits a release request to the AD 113 (Step S806).

Herein, the above-stated transmission of the release request to the AD 113 (Step S806) may be implemented when it is recognized (or can be determined) that a network initiated handover to the AD 112 succeeds following the handover to the AD 113 or a network initiated handover is superior to a UE initiated handover, in addition to the detection of a network initiated handover during a handover processing (Step S805). Herein, the release processing to the AD 113 may be subject to a further condition that a connection OK message to the AD 113 cannot be received within a predetermined time period.

The position registration message and the position registration response message of FIG. 6 to FIG. 8 are signaling for handover, which may be Proxy Binding Update or Proxy Binding Ack described in Non-Patent Document 1 (and FIG. 18) or Update Bearer Request or Update Bearer Response of FIG. 18.

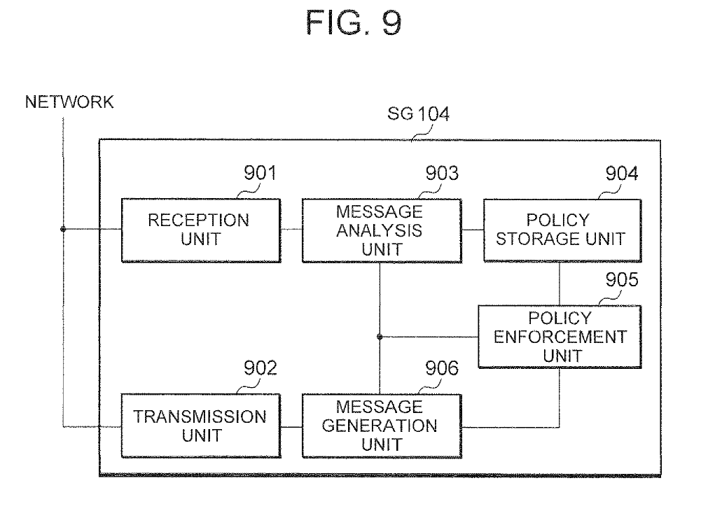

FIG. 9 illustrates an exemplary configuration of the SG 104 of Embodiment 1, Reception unit 901 is means to receive a message transmitted, and transmission unit 902 is means to transmit a message. Message analysis unit 903 is means to analyze the content of a message transmitted, for example, to analyze whether the position registration message from the AD 113 includes a policy, includes a trigger, or includes nothing.

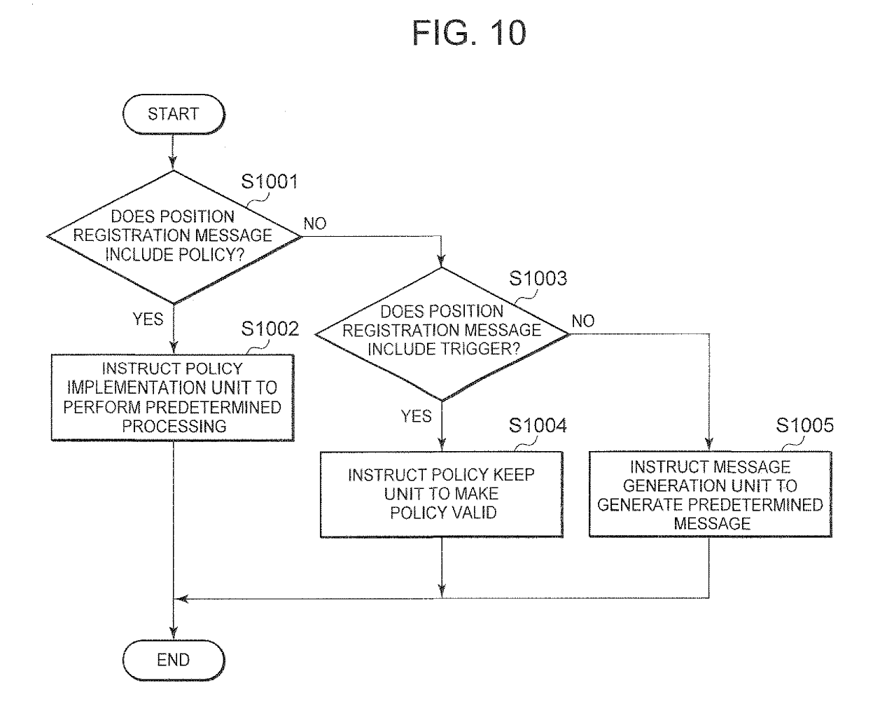

FIG. 10 illustrates an exemplary analysis flow. As shown in FIG. 10, the message analysis unit 903 analyzes whether a position registration message includes a policy or not (Step S1001). If a policy is included, the message analysis unit 903 instructs policy enforcement unit 905 to perform a predetermined processing (Step S1002), If no policy is included, the message analysis unit 903 analyzes whether the position registration message includes a trigger or not (Step S1003). If a trigger is included, the message analysis unit 903 instructs policy storage unit 904 to make the kept policy valid (Step S1004). If no trigger is included, the message analysis unit 903 instructs message generation unit 906 to generate a predetermined message (Step S1005).

In the case where a policy of the UE 100 is transmitted beforehand, the policy storage unit 904 keeps the policy, and if the message analysis unit 903 determines that a position registration message includes a trigger, such a policy is made valid. The policy enforcement unit 905 implements a policy included in the position registration message or the policy that the policy storage unit 904 keeps and is made valid. The message generation unit 906 generates a message in accordance with policy implementation by the policy enforcement unit 905 (or in a conventional manner in the absence of a policy).

### Embodiment 2

Since a communication network of Embodiment 2 is similar to that of Embodiment 1, the following describes Embodiment 2 with reference to FIG. 1. The UE 100 transmits beforehand, to the SG 104, a possibility of a handover of itself to the AD 113 (different type of network) and a policy relating to a timing of detach from the SG 104.

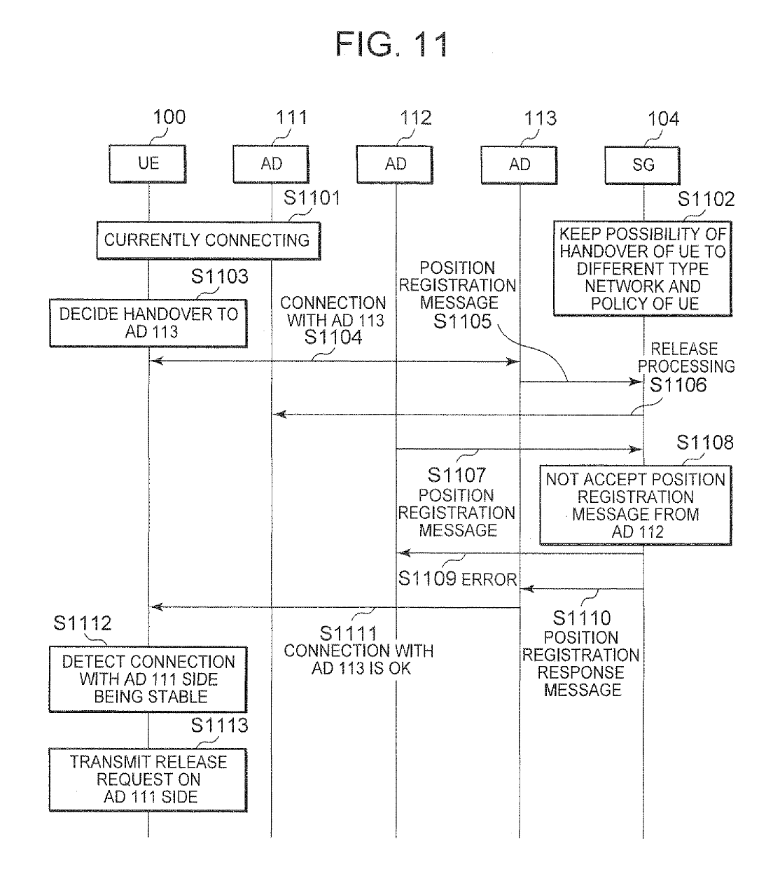

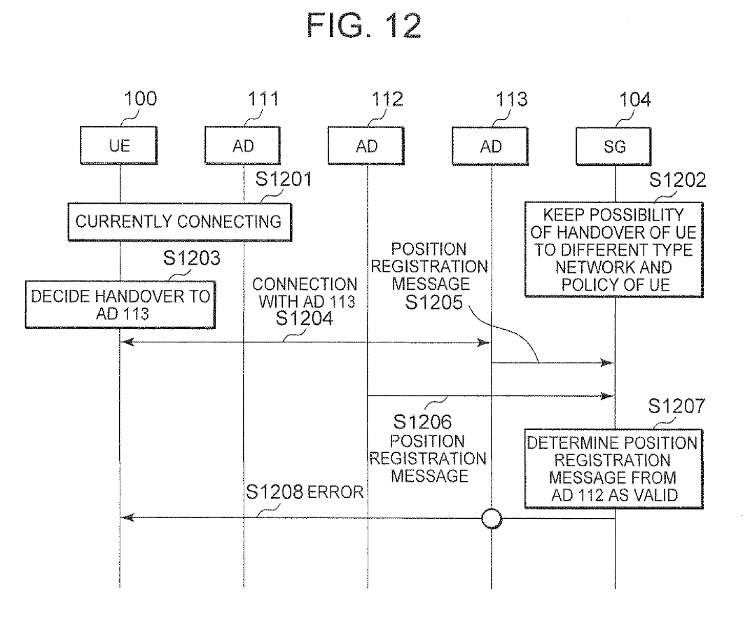

This policy includes the followings, for example: 1. As shown in FIG. 11, immediately after the SG 104 transmits (Step S1106) a message relating to a release processing following a handover from the AD 111 to the AD 113, when the SG 104 receives a position registration message from the AD 112 (Step S1107), to make the SG 104 not accept the position registration message (Step S1108), but to make the SG 104 return an error to the AD 112 (Step S1109); 2. Alternatively, as shown in FIG. 12, when the SG 104 receives a position registration message from the AD 112 before transmitting a message relating to a release processing to the AD 111 (Step S1206), to make the SG 104 determine that the position registration message from the AD 112 is valid (Step S1207) and to make the SG 104 not transmit a message relating to a release processing for a path of the AD 111. In this case, the UE 100 may notice that a handover from the AD 111 to the AD 113 fails or the SG 104 may return an error to the UE 100 (Step S1208).

Herein, the UE 100 may detect a failure in handover from the AD 111 to the AD 113 based on a status where link establishment with the AD 112 succeeds or where a connection OK message to the AD 113 cannot be received within a predetermined time period.

Herein, the position registration message and the position registration response message of FIG. 11 and FIG. 12 may be Proxy Binding Update and Proxy Binding Ack described in Non-Patent Document 1 and FIG. 18 or Update Bearer Request or Update Bearer Response of FIG. 18, for example. The message of the release processing of FIG. 11 may be Delete Bearer Request at Step S1806 of FIG. 18. The policy in this case may be transmitted to the SG 104 beforehand (not necessarily at the timing when the UE 100 implements a handover to the AD 113). This policy may be transmitted while being added to a message when position registration of the UE 100 is firstly performed with respect to the SG 104, or may be transmitted with a totally new message. Alternatively, the network side may keep this policy beforehand as a policy of the UE 100.

The following describes an exemplary configuration of the SG in Embodiment 2. Since elements thereof are similar to those of Embodiment 1, the following description refers to FIG. 9. Reception unit 901 is means to receive a message transmitted, and transmission unit 902 is means to transmit a message. Message analysis unit 903 is means to analyze the order of transmitted messages. Policy storage unit 904 keeps a policy of the UE 100 transmitted beforehand, and policy enforcement unit 905 is means to decide a message to be transmitted in accordance with the order of transmitted messages. Message generation unit 906 generates a message decided by the policy enforcement unit 905, and passes the same to the transmission unit 902 in the decided order.

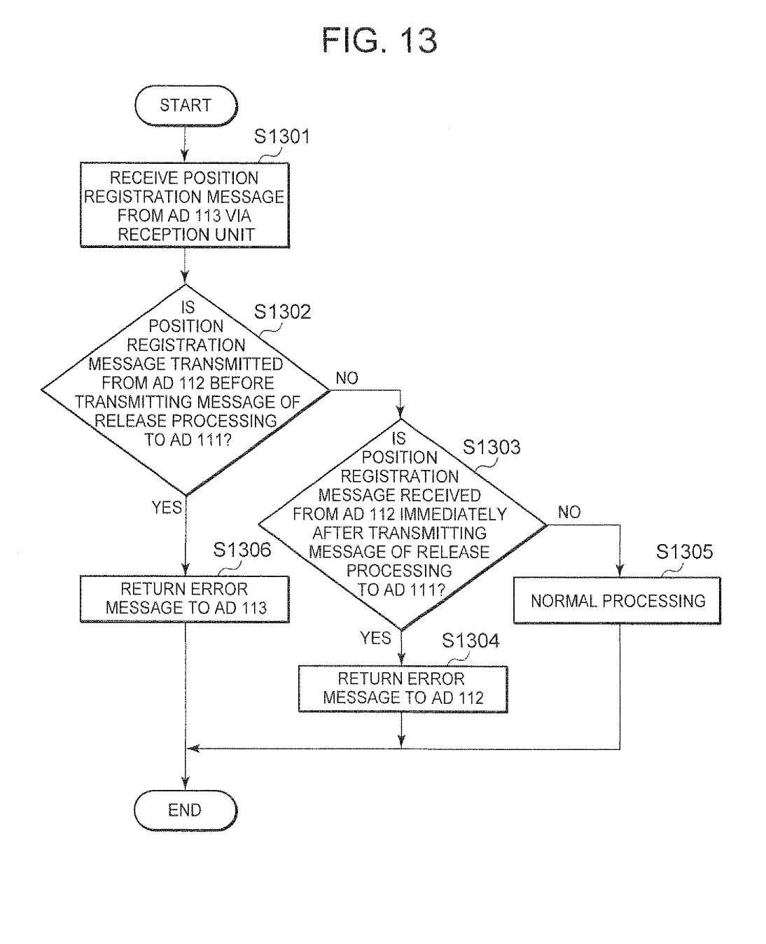

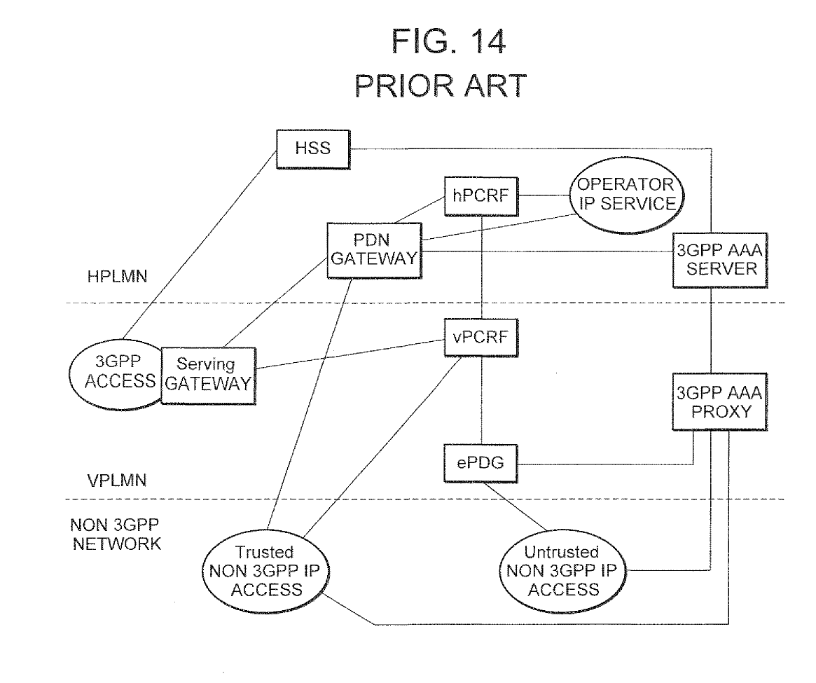

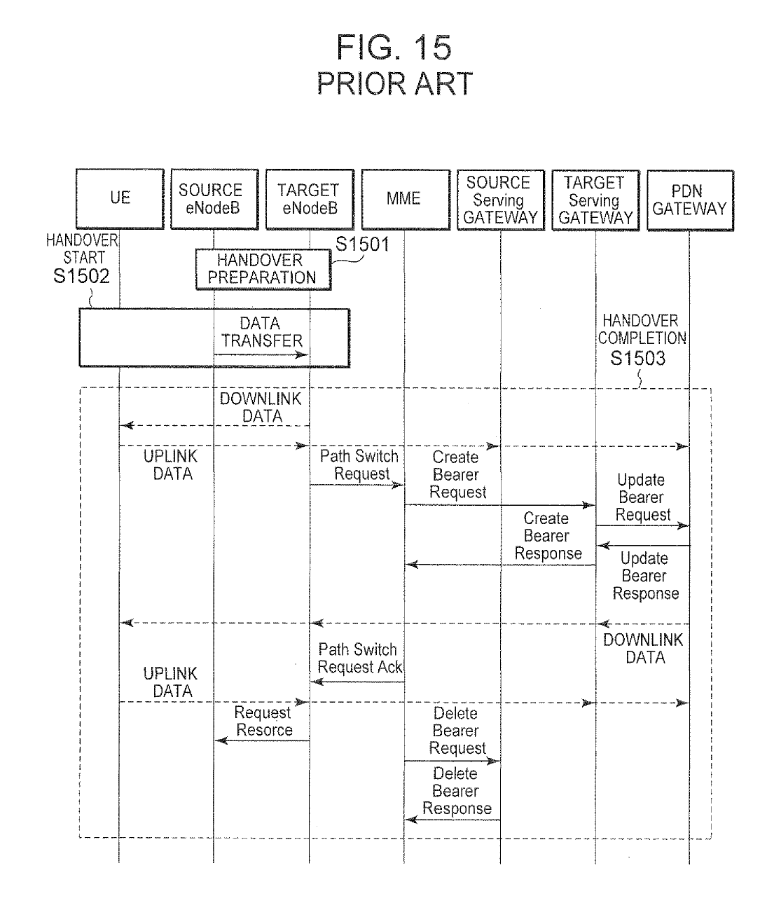

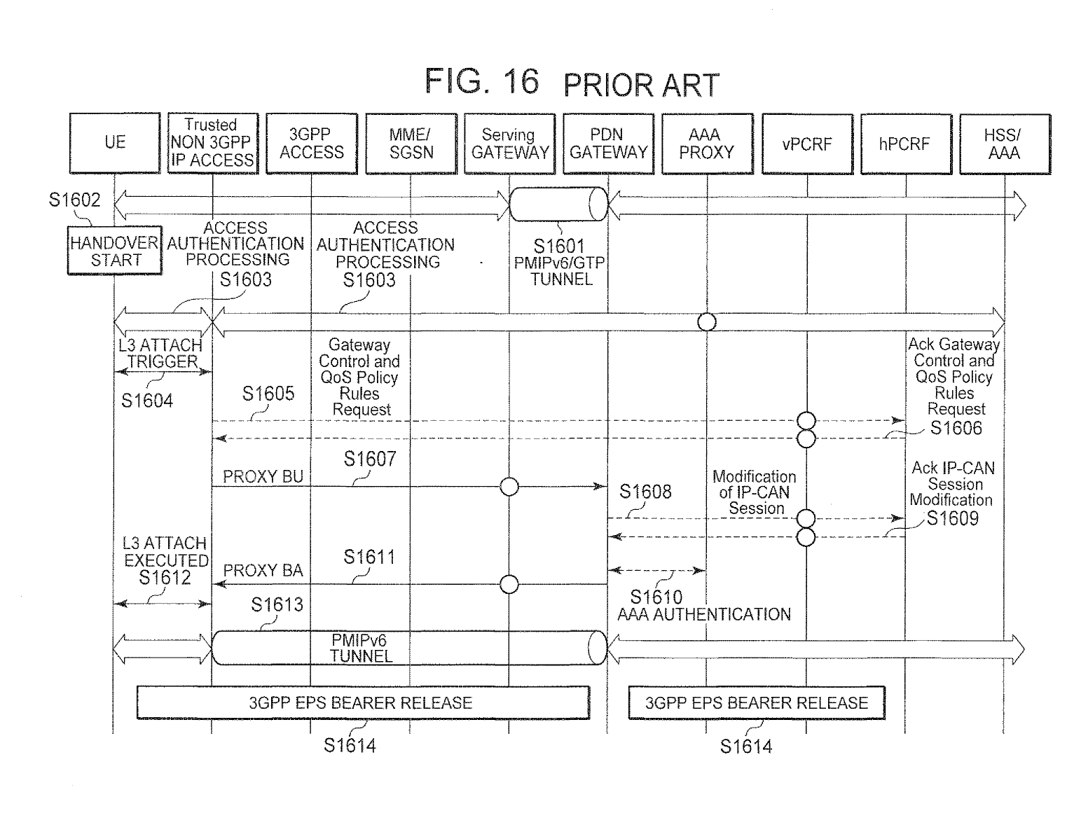

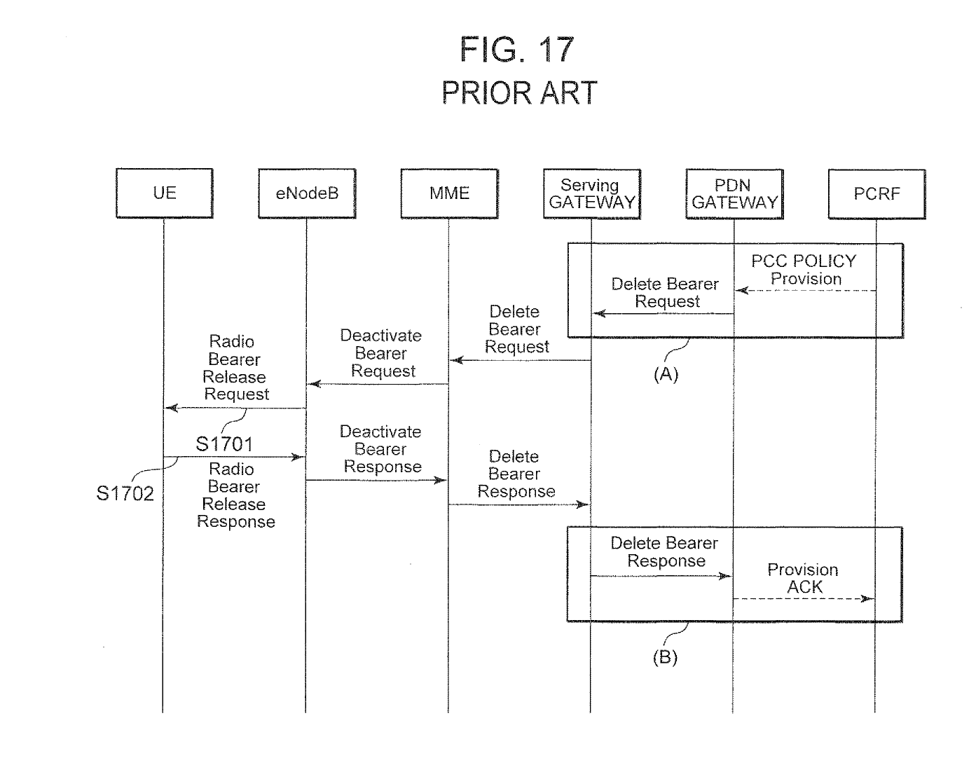

Referring now to FIG. 13, the following describes an exemplary processing by the policy enforcement unit 905. After receiving a position registration message from the AD 113 via the reception unit 901 (Step S1301), the policy enforcement unit 905 determines whether a position registration message is transmitted or not from the AD 112 before transmitting a message of a release processing to the AD 111 (Step S1302). If the position registration message is not transmitted from the AD 112, the policy enforcement unit 905 determines whether a position registration message is received or not from the AD 112 immediately after transmitting a message of a release processing to the AD 111 (Step S1303).

In the case where the position registration message is received from the AD 112, the policy enforcement unit 905 returns an error message (including a message of a handover failure) to the AD 112 (Step S1304). On the other hand, in the case where the position registration message is not received from the AD 112, the policy enforcement unit 905 performs a normal processing (Step S1305). In the case where it is determined at Step S1302 that a position registration message is transmitted from the AD 112 before transmitting a message of a release processing to the AD 111, the policy enforcement unit 905 returns an error message (including a message of a handover failure) to the AD 113 (Step S1306).

Note that each functional block used in the explanations of each embodiment of the present embodiment may be typically implemented as a LSI that is an integrated circuit. These blocks may be individually configured as one chip, or one chip may include a part or all of the functional blocks. LSIs may be called an IC (Integrated Circuit), a system LSI, a super LSI, and an ultra LSI depending on the degree of integration.

A technique for integrated circuit is not limited to a LSI, but an integrated circuit may be achieved using a dedicated circuit or a general-purpose processor. A FPGA (Field Programmable Gate Array) capable of programming after manufacturing a LSI and a reconfigurable processor capable of reconfiguring connection and setting of a circuit cell inside a LSI may be used.

Further, if a technique for integrated circuit that replaces LSIs becomes available by the development of a semiconductor technique or derived techniques, functional blocks may be naturally integrated using such a technique. For instance, biotechnology may be applied thereto.

### INDUSTRIAL APPLICABILITY

A handover processing method and a mobile terminal and a communication management device used in the method of the present invention enable a seamless handover of the mobile terminal, and can avoid double reservation. Therefore the handover processing method and the mobile terminal and the communication management device used in the method of the present invention are effective to the case where a plurality of entities exists to control a mobile terminal handover and mobile terminal handovers by the respective control entities occur.

1-16. (canceled)

17. A handover processing method for a mobile terminal, the mobile terminal performing communication with a correspondent node via a communication network including a plurality of access networks in a communication system, a plurality of control entities that control a handover of the mobile terminal existing in the communication system, comprising the steps of:
a step where the mobile terminal decides to connect with a desired access network among the plurality of access networks;
a step where the mobile terminal detects a possibility of occurrence of a network initiated handover processing a predetermined device of the communication network performs as one of the control entities; and
a step where the mobile terminal transmits, based on the detection, a connection request message to a base station disposed in the desired access network, the connection request message requesting a connection with the desired access network and including predetermined information to maintain a connection with an access network with which the mobile terminal is currently connecting.

18. The handover processing method according to claim 17, wherein the possibility of occurrence of a network initiated handover processing is detected based on whether or not radio wave intensity the mobile terminal receives being predetermined radio wave intensity or lower, or whether or not the mobile terminal transmitting a report indicating a result of examination on an access network environment surrounding the mobile terminal.

19. The handover processing method according to claim 17, wherein the predetermined information includes information indicating a policy of a handover processing when a handover of the mobile terminal is occurred.

20. The handover processing method according to claim 17, wherein when the mobile terminal detects the network initiated handover processing after the connection request message is transmitted, the mobile terminal transmits, to the base station disposed in the desired access network, a release message to disconnect the connection with the desired access network.

21. The handover processing method according to claim 17, wherein the predetermined information includes information to make a predetermined device of the communication network managing communication with the correspondent node conduct a processing in accordance with information indicating a policy of a handover processing of the mobile terminal, the information being kept by the predetermined device.

22. A handover processing method for a mobile terminal, the mobile terminal performing communication with a correspondent node via a communication network including a plurality of access networks in a communication system, a plurality of control entities that control a handover of the mobile terminal existing in the communication system, comprising the steps of:
when a predetermined device of the communication network managing communication of the mobile terminal with the correspondent node receives a first message and a second message, the first message from the mobile terminal requesting connection switching to a base station in a desired access network among the plurality of access networks, and the second message requesting connection switching to a base station of a connection target of the mobile terminal that the communication network decides as an entity,
a step where a predetermined device of the communication network determines whether or not a message to release a connection of the mobile terminal with a base station with which the mobile terminal is currently connecting is transmitted to the base station with which the mobile terminal is currently connecting after reception of the first message and before reception of the second message;
a step of, when it is determined that the message is transmitted, deciding not to accept a processing of the second message; and
a step of, when it is determined that the message is not transmitted, determining that the second message is valid and performing a processing in accordance with the second message.

23. The handover processing method according to claim 22, wherein when it is decided not to accept a processing of the second message, a predetermined device of the communication network transmits an error message indicating not acceptance to a base station that transmits the second message.

24. The handover processing method according to claim 22, wherein when a processing is performed in accordance with the second message, a predetermined device of the communication network transmits an error message indicating that the mobile terminal cannot perform a desired connection to the mobile terminal via a base station that transmits the first message.

25. A mobile terminal used in a handover processing method for the mobile terminal, the mobile terminal performing communication with a correspondent node via a communication network including a plurality of access networks in a communication system, a plurality of control entities that control a handover of the mobile terminal existing in the communication system, there being a possibility of each of the plurality of control entities generating a handover processing of the mobile terminal, comprising:
decision unit that decides a connection with a desired access network among the plurality of access networks;
detection unit that detects a possibility of occurrence of a network initiated handover processing a predetermined device of the communication network performs as one of the control entities;
message generation unit that generates a connection request message based on the detection by the detection unit, the connection request message requesting a connection with the desired access network and including predetermined information to maintain a connection with an access network with which the mobile terminal is currently connecting; and
transmission unit that transmits the generated connection request message to a base station disposed in the desired access network.

26. The mobile terminal according to claim 25, wherein the possibility of occurrence of a network initiated handover processing is detected by the detection unit based on whether or not radio wave intensity the mobile terminal receives being predetermined radio wave intensity or lower, or whether or not the mobile terminal transmitting a report indicating a result of examination on an access network environment surrounding the mobile terminal.

27. The mobile terminal according to claim 25, wherein the predetermined information includes information indicating a policy of a handover processing when a handover of the mobile terminal is occurred.

28. The mobile terminal according to claim 25, wherein when detecting the network initiated handover processing after the connection request message is transmitted,
the message generation unit generates a release message to disconnect the connection with the desired access network, and
the transmission unit transmits the generated release message to the base station disposed in the desired access network.

29. The mobile terminal according to claim 25, wherein the predetermined information includes information to make a predetermined device of the communication network managing communication with the correspondent node conduct a processing in accordance with information indicating a policy of a handover processing of the mobile terminal, the information being kept by the predetermined device.

30. A communication management device used in a handover processing method for a mobile terminal, the mobile terminal performing communication with a correspondent node via a communication network including a plurality of access networks in a communication system, a plurality of control entities that control a handover of the mobile terminal existing in the communication system, the communication management device managing the communication comprising:
reception unit that receives a first message and a second message, the first message from the mobile terminal requesting connection switching to a base station in a desired access network among the plurality of access networks, and the second message requesting connection switching to a base station of a connection target of the mobile terminal that the communication network decides as an entity;
transmission unit that transmits a release message to release a connection of the mobile terminal with a base station with which the mobile terminal is currently connecting to the base station with which the mobile terminal is currently connecting;
determination unit that, after reception of the first message and before reception of the second message, determines whether or not the transmission unit transmits the release message to the base station with which the mobile terminal is currently connecting; and
processing unit that, when it is determined that the message is transmitted, decides not to accept a processing of the second message; and when it is determined that the message is not transmitted, determines that the second message is valid and performs a processing in accordance with the second message.

31. The communication management device according to claim 30, further comprising message generation unit that, when the processing unit decides not to accept a processing of the second message, generates an error message indicating not acceptance, wherein
the transmission unit transmits the generated error message to a base station that transmits the second message.

32. The communication management device according to claim 30, further comprising message generation unit that, when the processing unit performs a processing in accordance with the second message, generates an error message indicating that the mobile terminal cannot perform a desired connection, wherein
the transmission unit transmits the generated error message to the mobile terminal via a base station that transmits the first message.
